(19) United States
(12) Patent Application Publication
(10) Pub. No.: US 2012/0226625 A1
(43) Pub. Date: Sep. 6, 2012

(54) SHIPMENT EVALUATION SYSTEM

(75) Inventors: William PFEFFER, Corvallis, MT (US); Naomi J. CHEENEY, Corvallis, MT (US)

(73) Assignee: CHEXXE SOFTWARE INC., Hamilton, MT (US)

(21) Appl. No.: 13/409,789

(22) Filed: Mar. 1, 2012

Related U.S. Application Data
(60) Provisional application No. 61/447,936, filed on Mar. 1, 2011.

(51) Int. Cl. G06Q 10/08

(52) U.S. Cl. 705/341

(57) ABSTRACT

A system and method for receiving scheduled shipping information, including information on scheduled package delivery time and billing information, receiving actual shipping information including actual delivery time, and actual billing information for said package, comparing the schedule information to actual information, and reporting the results including billing discrepancies or late deliveries. Certain embodiments may check climate conditions on the route of travel and determine if any shipping refund is due. Certain embodiments may also identify other carrier service anomalies and apply for and mage refunds. Indicia are used to display the status of a shipment, the status of a refund. Shipping information from multiple carriers may be aggregated into a single comprehensive system.

### PRIORITY

This application claims the benefit of provisional patent application 61/447,936 entitled “Shipping Evaluation System” filed Mar. 1, 2011 by the same inventors and is hereby included by reference as if fully set forth herein.

### BACKGROUND

In the field of common carriers including but not limited to FedEx, UPS or DHL, carriers often make guarantees on package delivery by a shipment commitment date and time. If a shipment from such a carrier is delivered before its commitment date and time, the carriers is said to have fulfilled its commitment date. However, if the carrier fails to meet its commitment date and time for a reason other than an act of nature (bad weather, earthquakes, catastrophes, ad the like), the guarantee is activated and the carrier owes the shipper a refund. However, the onus to detect and claim these commitment-failure shipments lies with the shipper and not the carrier.

When a carrier delivers a package late because of a natural event such as bad weather, the shipper has no easy way to verify that weather conditions caused the delay. This becomes significant since common carriers are not immune from mistakes and refunds have been issued on packages declared late due to weather but alleged to be late for carrier-related reasons. As above, the responsibility of investigating a weather-related late delivery and arguing against it falls on the shipper and not the carrier.

In addition to failed commitment dates, carriers also make billing errors. As a package of a shipment proceeds through the carrier shipping system, its weight and dimensions are recorded by the carrier. These values for weight and dimension, along with delivery address and service type, are used by the carrier to assess the transportation fee and any weight-based or dimension-based surcharge fee for the package. Weight-based package surcharges arise when a package exceeds a certain weight limit specified by the carrier. Similarly, dimension-based surcharges arise when a package exceeds one or more dimension limitations imposed by the carrier. Finally, the carrier can base the shipping weight on the dimension rather than the physical weight of the package. This is referred to as the dimensional weight of a package and is simply the length multiplied by width and height of a packaged divided by a constant. Each carrier has its own constant and rules determining when dimensional weight is used over actual weight. Should a shipper note a billing error due to an incorrect charge based on an incorrect carrier-recorded weight, dimension or a combination of the two, the shipper may request a billing adjustment. As with requesting refunds for late packages, the onus of discovering these billing errors, determining the root cause (incorrect weight or dimensions) and requesting a billing adjustment is placed on the shipper.

Finally, should a shipper have a late-delivered package that falls under a carrier guarantee or a package that has been billed incorrectly due incorrect weight, dimensions, or shipping surcharge the carrier gives the shipper a limited number of days to make a claim or billing adjustment. Once that time has elapsed, the shipper is prohibited from making a claim or requesting a billing adjustment using the normal procedures supplied by the carrier, but instead will have to make a special appeal to the carrier to have the refund or adjustment completed.

What is needed is a simple, cost effective system that would allow for better management of a shipping operation including, but not limited to, quickly identifying billing errors and making claims against carriers.

### SUMMARY

Disclosed herein is a system for collecting and organizing the shipment data from a shipper and corresponding data from the carrier, a process of comparing the two sets of data to yield a reduced set of data from shipments that are identified as being delivered late and incorrectly billed.

The system described herein gathers data from the shipper such as shipping date, package weight, package dimensions, destination and requested service. It also provides for gathering the corresponding data from the carrier selected for the particular shipment. In addition, it also gathers the billing amount for the shipment from the carrier. The system then compares predicted delivery dates and times to actual delivery dates and time to determine if there was a failure to deliver by the committed date. For packages identified as late because of weather, the system may extract weather information from the delivery route and destination at times on or near to those times when the package was present at those locations. The system may also compares predicted bill amounts for a shipment to the actual bill amounts from the carrier to determine if the package was incorrectly charged. Moreover, the system may alert the shipper to file a claim or automatically request a billing adjustment prior to the carrier deadline. The system may also provides associated shipment and billing reporting functions.

The processes described herein may be performed on a system operated under the auspices of a system owner or alternatively provided as a service.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 represents various components which may be included according to the current disclosure.

FIG. 2 depict an embodiment of a Shipment evaluation system flow.

FIG. 3A represents an embodiment of a first scenario of a shipment creation process.

FIG. 3B represents an embodiment of a second scenario of a shipment creation process.

FIG. 3C represents an embodiment of a third scenario of a shipment creation process.

FIG. 4A represents an embodiment of a first scenario of a shipment delivery update process.

FIG. 4B represents an embodiment of the second scenario of a shipment delivery update process.

FIG. 4C represents a first scenario in a shipment billing update process.

FIG. 4D represents a second scenario in a shipment billing update process.

FIG. 5 depicts a evaluation process used to determine if a shipment was delivered late or incorrectly billed.

FIG. 6 shows aspects of a reporting and alerting feature of a shipment delivery system.

FIG. 7 illustrates certain aspects of a user interface which may be used on certain embodiments.

FIG. 8 shows details of a refund paid report for certain embodiments.

FIG. 9 shows certain controls which may be employed in refund tracking operations.

FIG. 10 shows an interface for package routing and weather information.

### DETAILED DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

### Lexicography

The term “climatological information” generally refers to information concerning weather, flooding, earthquakes, natural disasters and the like.

The terms “common carrier”, “carrier” and the like generally refer to a person or entity engaged in the process of transporting a package, letter or container.

The term “HTML Injection” generally refers to injecting HTML code into a web server's response to alter the content to the end user. This is also known as cross site scripting.

The term “shipper” generally refers to a person or entity that desires a package, letter or container to be transported.

The term “extension” and “browser extension” and the like generally refer to a computer program, applet or instructions that extend the functionality of a web browser in some way. Depending on the browser, the term may be distinct from similar terms such as plug-in or add-on.

The terms “Shipment Delivery System” or “Shipment Evaluation System” generally refer to aspects and embodiments according to the current disclosure. References to these terms are illustrative only and are not intended to be limiting in any way.

The term “structured data” generally refers to data stored in a meaningful fashion such that a processor may be instructed to access the data. Examples include but are not limited to databases, relational databases, text files, XML file and the like.

### System Elements

### Processing System

The methods and techniques described herein may be performed on a processor based device. The processor based device will generally comprise a processor attached to one or more memory devices or other tools for persisting data. These memory devices will be operable to provide machine-readable instructions to the processors and to store data, including data acquired from remote servers. The processor will also be coupled to various input/output (I/O) devices for receiving input from a user or another system and for providing an output to a user or another system. These I/O devices include human interaction devices such as keyboards, touchscreens, displays and terminals as well as remote connected computer systems, modems, radio transmitters and handheld personal communication devices such as cellular phones, “smart phones” and digital assistants.

Certain embodiments may include mass storage devices such as disk drives and flash memory modules as well as connections through I/O devices to servers containing additional storage devices and peripherals. Certain embodiments may employ multiple servers and data storage devices thus allowing for operation in a cloud or for operations drawing from multiple data sources. The inventor contemplates that the methods disclosed herein will operate over a network such as the Internet, and may be effectuated using combinations of several processing devices, memories and I/O.

The processing system may be a wireless devices such as a smart phone, personal digital assistant (PDA), laptop, notebook and tablet computing devices operating through wireless networks. These wireless devices may include a processor, memory coupled to the processor, displays, keypads, WiFi, Bluetooth, GPS and other I/O functionality.

### Client Server Processing

Client-server processing includes, but is not limited to operations between multiple processor-based devices wherein the processing is partially performed on different computing devices. Conventionally a server is coupled to one or more databases and to a network. A user accesses the server by a computer communicably coupled to the network. Alternatively the user may access the server through the network by using a smart device such as a telephone or PDA. The smart device may connect to the server through an access point coupled to the network.

Conventionally, client server processing operates by dividing the processing between two devices such as a server and a smart device such as a cell phone or other computing device. The workload is divided between the servers and the clients according to a predetermined specification. For example in a “light client” application, the server does most of the data processing and the client does a minimal amount of processing, often merely displaying the result of processing performed on a server.

According to the current disclosure, client-server applications are structured so that the server provides machine-readable instructions to the client device and the client device executes those instructions. The interaction between the server and client indicates which instructions are transmitted and executed. In addition, the client may, at times, provide for machine readable instructions to the server, which in turn executes them. Several forms of machine readable instructions are conventionally known including applets and are written in a variety of languages including Java and JavaScript.

Client-server applications also provide for software as a service (SaaS) applications where the server provides software to the client on an as needed basis.

In addition to the transmission of instructions, client-server applications also include transmission of data between the client and server. Often this entails data stored on the client to be transmitted to the server for processing. The resulting data is then transmitted back to the client for display or further processing.

One having skill in the art will recognize that client devices may be communicably coupled to a variety of other devices and systems such that the client receives data directly and operates on that data before transmitting it to other devices or servers. Thus data to the client device may come from input data from a user, from a memory on the device, from an external memory device coupled to the device, from a radio receiver coupled to the device or from a transducer coupled to the device. The radio may be part of a wireless communications system such as a “WiFi” or Bluetooth receiver. Transducers may be any of a number of devices or instruments such as thermometers, pedometers, health measuring devices and the like.

A client-server system may rely on “engines” which include processor-readable instructions (or code) to effectuate different elements of a design. Each engine may be responsible for differing operations and may reside in whole or in part on a client, server or other device. As disclosed herein certain embodiments may include a display engine, a data engine, a user interface and the like. These engines may seek and gather information about events from remote data sources.

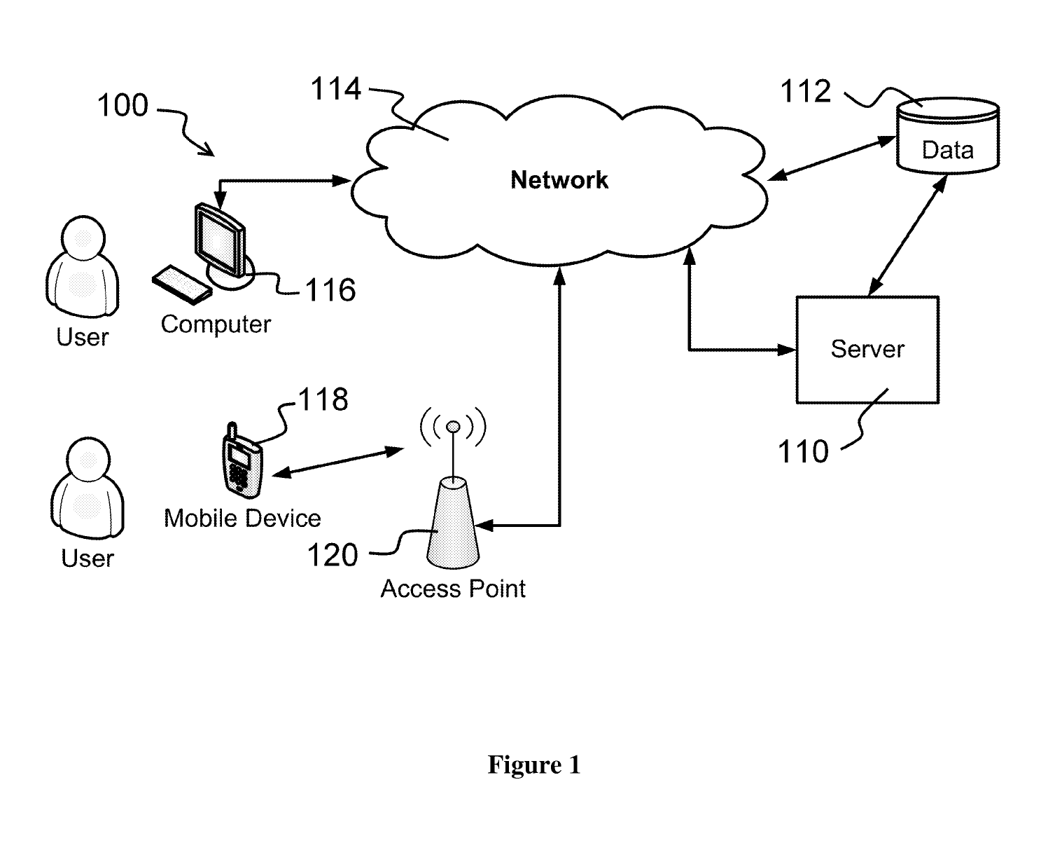

FIG. 1 shows a functional block diagram of a client server system 100 that may be employed for some embodiments according to the current disclosure. In the FIG. 1 a server 110 is coupled to one or more databases 112 and to a network 114. The network may include routers, hubs and other equipment to effectuate communications between all associated devices. A user accesses the server by a computer 116 communicably coupled to the network 114. The computer 116 includes a sound capture device such as a microphone (not shown). Alternatively the user may access the server 110 through the network 114 by using a smart device such as a telephone or PDA 118. The smart device 118 may connect to the server 110 through an access point 120 coupled to the network 114. The mobile device 118 includes a sound capture device such as a microphone.

References in the specification to “one embodiment”, “an embodiment”, “an example”, “for example”, etc., indicate that the embodiment described may include a particular feature, structure or characteristic, but every embodiment or example may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

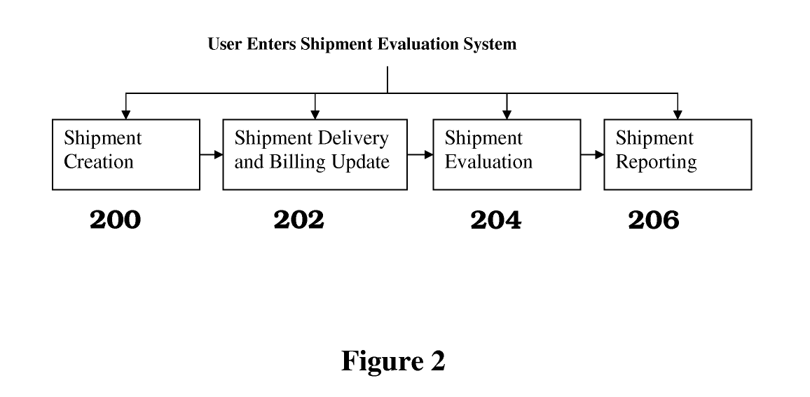

FIG. 2 depicts an overview of a shipment evaluation system work flow. Starting the process with a new shipment, the user enters the shipment evaluation system at the Shipment Creation point 200 and proceeding through to a delivery and billing update 202, a shipment evaluation 204 to a shipment reporting function 206.

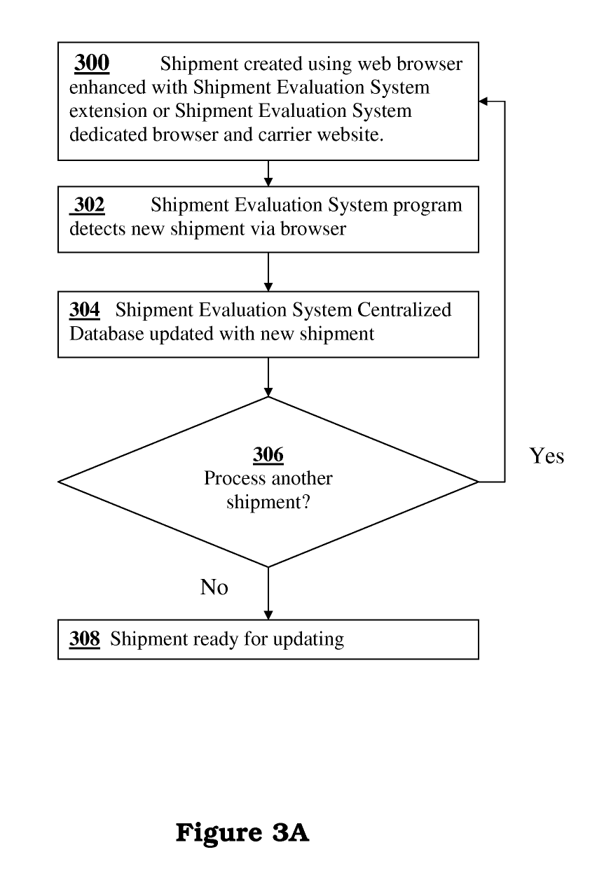

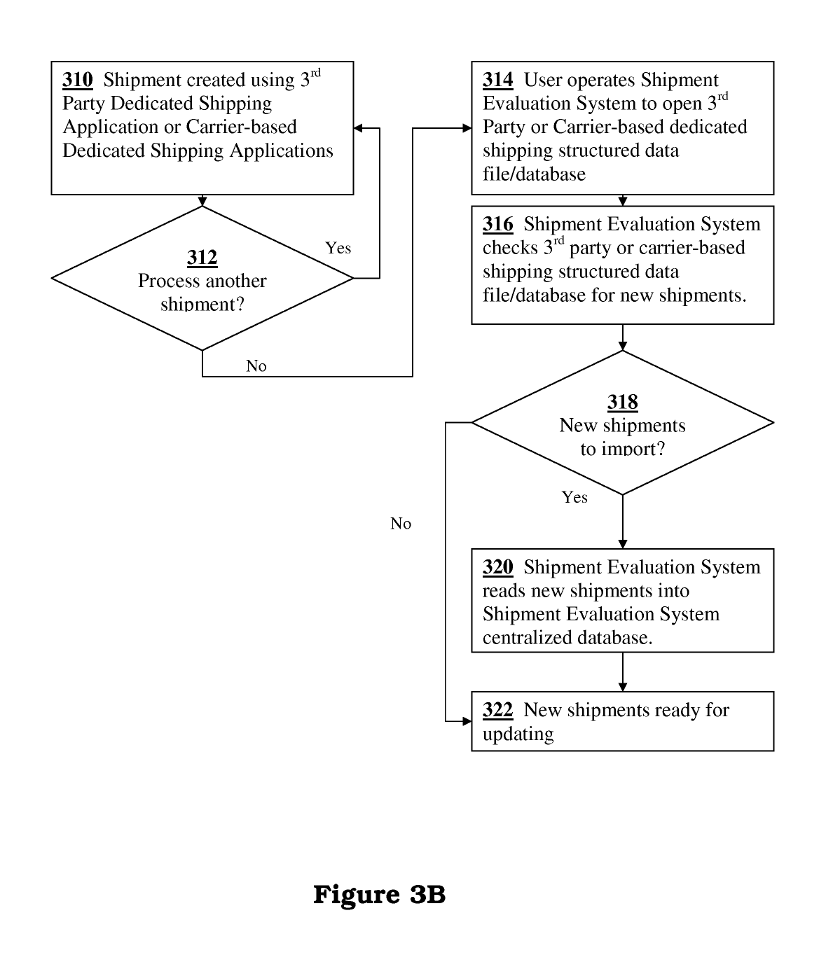

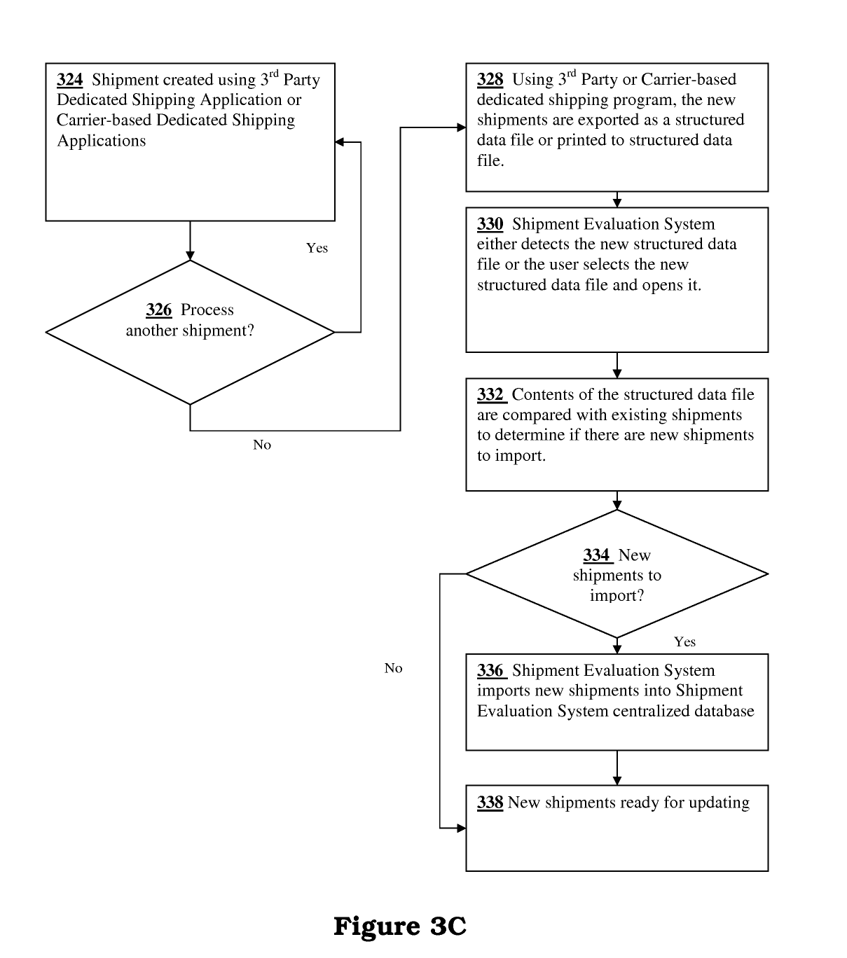

FIG. 3A represents an embodiment of a first scenario of a shipment creation process. In the scenario depicted in FIG. 3A, a user navigates to the carrier web site using the dedicated internet browser or an internet browser equipped with the shipment evaluation system extension 300. On the website of the carrier, the user enters the shipment specifics: dimensions (length, width and height), weight, shipper name, shipper address, carrier service, ship date, recipient name, and recipient address.

Once the shipment information is entered, the carrier, using the shipment specifics, may add calculated shipment information to the web page which may include: dimensional weight (weight based on dimensions), estimated arrival date (based on selected service), shipping cost (based on selected service), shipping discount (based on selected service), shipping surcharges (based on selected service, recipient address, weight, dimensions, taxes, miscellaneous shipping fees and the like.

After the user's shipment information has been entered and carrier additions have been made, a shipping label is printed. A trigger 302, such as the process of creating a shipping label, causes the shipment evaluation system to first generate predicted shipping costs using carrier-based rate tables and surcharge rules and then save the user entered information, the carrier entered information and the predicted shipping costs to the shipment evaluation system database 304. If the user has another shipment to create 306, the process may be repeated 300. If not, the saved shipment information is ready for updating 308 when the user enters the shipment evaluation system from point 202 in FIG. 2.

To create a shipment using the embodiment described in FIG. 3b, the user generates a shipment using a 3rd party shipping application 310. This 3rd party shipping application may be supplied by the carrier. The user enters the shipment specifics mention in the embodiment for FIG. 3a. The 3rd party application may add the additional shipping information mentioned in the embodiment for FIG. 3a. If the user has another shipment to process 312, the creation process 310 is repeated. If not, the operator uses the shipment evaluation system to open the 3rd party shipping application database or structured data file 314. The shipment evaluation system compares the shipments in its database with those in the 3rd party application and determines if there are new shipments to add to the shipment evaluation system database 316. If new shipments exist within the 3rd party application 318, the shipment evaluation system reads the new shipments into the shipment evaluation system database 320. Predicted shipping costs may be calculated and added at this point as well. When all the new shipments have been added to the shipment evaluation system database, or if there are no new shipments to add, the shipment evaluation system is ready for updating 322 by the user entering the shipment evaluation system from point 202 in FIG. 2 above.

Creating a shipment using the embodiment of FIG. 3c the operator creates a shipment using a 3rd party application 324. The user enters the shipment specifics mention in the scenario for FIG. 3a. The 3rd party application may add the additional shipping information mentioned in the scenario for FIG. 3a. If the user has another shipment to process 326, the creation process 324 is repeated. If all shipments have been created, the operator uses the 3rd party shipping application to export the new shipments as a structured data file or print the new shipments as a structured data file 328. The shipment evaluation system either detects the newly exported structured data file or the user selects the new structured data file and opens it for reading 330. The shipment evaluation system compares the shipments in its database with those from the structured data file and determines if there are new shipments to add to the shipment evaluation system database 332. If new shipments exist within the structured data file 334, the shipment evaluation system reads the new shipments into the shipment evaluation system database 336. Predicted shipping costs may be calculated and added at this point as well. When all the new shipments have been added to the shipment evaluation system database, or if there are no new shipments to add, the shipment evaluation system is ready for updating 338 by the user entering the shipment evaluation system at position 202 in FIG. 2.

Alternatively an operator may wish to export a history of previous shipments for evaluation; this could be effectuated by the operator exporting the shipment history from point 338 in FIG. 3.

Shipments are updated with respect to delivery information and billing information by the user entering the shipment evaluation system at position 202 in FIG. 2. Each shipment is updated with respect to delivery information and billing information. In this disclosure, delivery information is presented first followed by the update of billing information. One having skill in the art will appreciate that billing information could easily be updated first. If the carrier website or 3rd party application did not add the calculated shipment information discussed in scenario presented for FIG. 3a, it is at this point in the shipment evaluation system where the shipment evaluation system attempts to generate that information using published information from the carrier and saves it with the updated shipment information.

To update the shipment delivery information, the operator may use the shipment evaluation system dedicated browser or a browser equipped with the shipment evaluation system extension to make a request to the carrier web site for updated delivery information 400. The carrier responds with a web page containing the updated shipment delivery information 402.

If the operator is using the shipment evaluation system dedicated browser, the shipment evaluation system reads the updated information directly into an array structure 404. For each shipment in the update array, the shipment evaluation system attempts to match that shipment using the unique shipment identification number. For example and without limitation through the use of a tracking number to identify a corresponding entry in the shipment evaluation system database. If a match is found and the package has been delivered, that shipment is updated with the delivery date and time 406. If the end of the update array has not been reached 408, an attempt is made to update another shipment 406. Once all packages have been evaluated for a delivery update, shipment evaluation system is ready for a billing update 410.

If the operator uses a browser with the shipment evaluation system extension, the updated shipment delivery information is written as a temporary structured data file that is detected by the shipment evaluation system 412. This triggers the shipment evaluation system to read the updated shipment information into an array structure 414. From this point, the flow of the system proceeds to 406 and proceeds as discussed above.

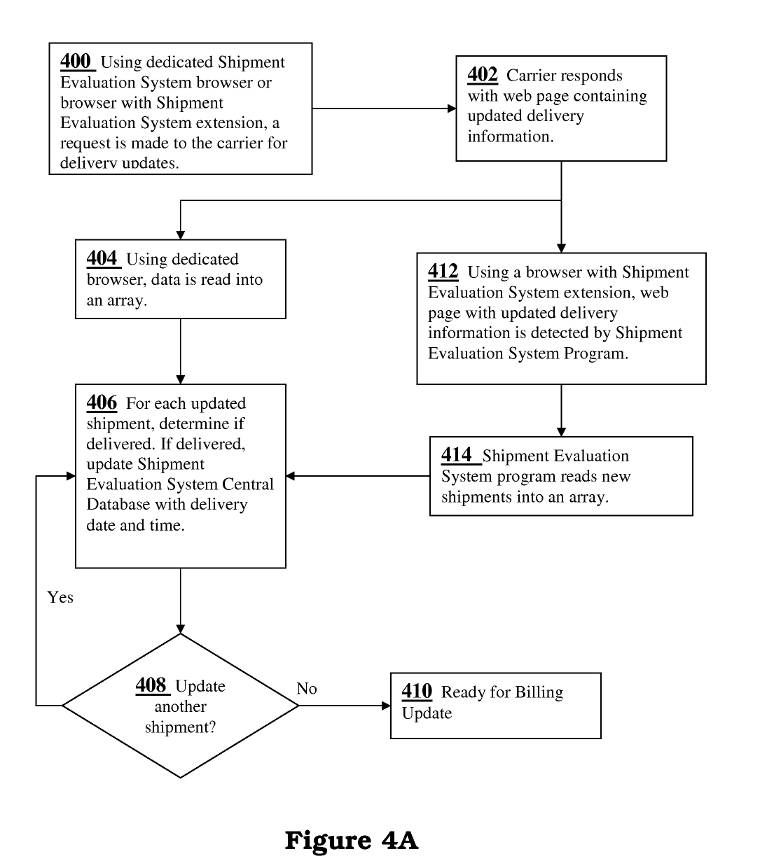

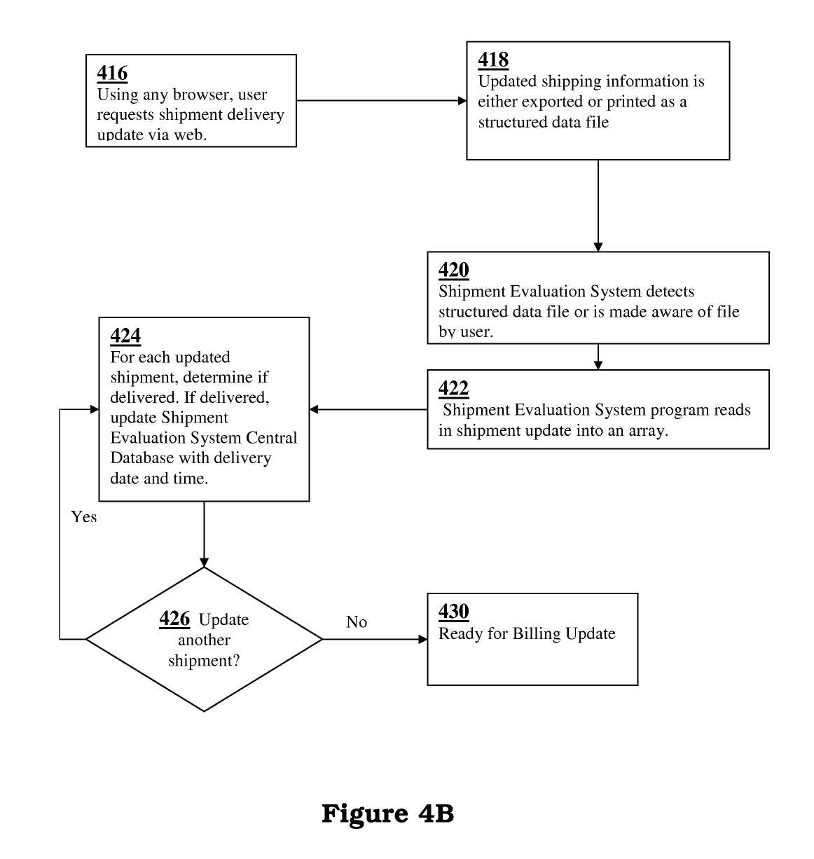

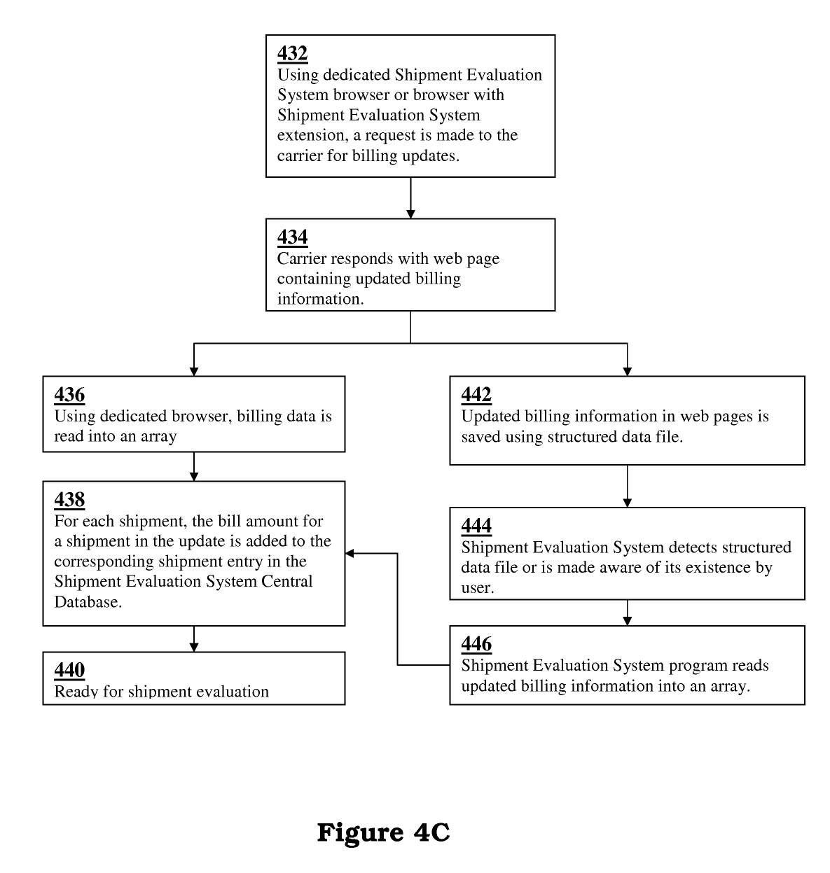

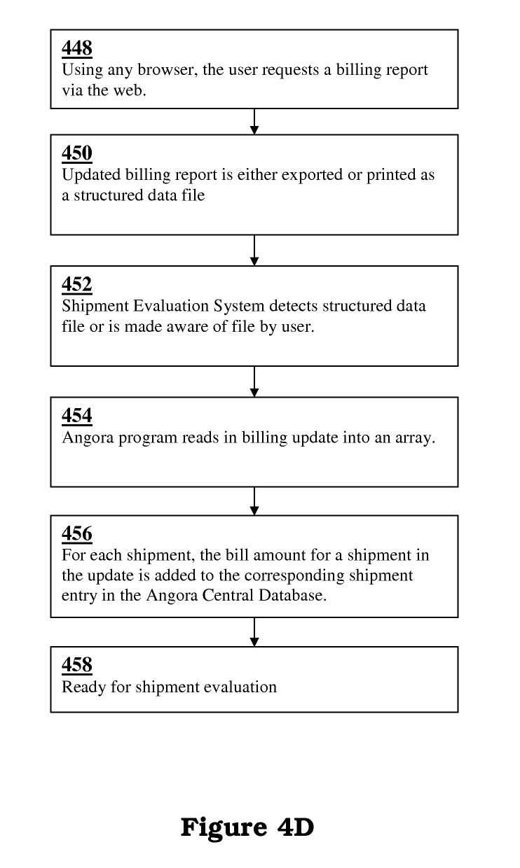

In the shipment delivery update example of FIG. 4B, the operator uses a browser to request a shipment delivery update from the carrier via the internet 416. The carrier responds with a webpage containing the requested delivery updates. The operator exports the updated delivery information or prints the updated delivery information to a structured data file 418. The shipment evaluation system detects the new structured data file or is made aware of it by the operator 420. This triggers the shipment evaluation system to read the delivery updates into an array structure 422. For each shipment in the update array, the shipment evaluation system attempts to match that shipment using the unique shipment identification number to a corresponding entry in the shipment evaluation system database. If a match is found and the package has been delivered, that shipment is updated with the delivery date and time 424. If the end of the update array has not been reached 426, an attempt is made to update another shipment 424. Once all packages have been evaluated for a delivery update, shipment evaluation system is ready for a billing update 430.

Upon completion of the delivery update, the operator can continue to the billing update. In the embodiment of FIG. 4C, the operator contacts the carrier using either the shipment evaluation system dedicated browser or a browser enabled with the shipment evaluation system extension and requests a billing update 432. The carrier responds with information such as a web page containing the billing update 434. Alternatively, if the operator uses a shipment evaluation system dedicated browser, the updated billing information is read directly into an array structure 436. For each shipment in the update array, the shipment evaluation system attempts to match that shipment using the unique shipment identification number to a corresponding entry in the shipment evaluation system database. If a match is found and the package has been billed, that shipment is updated with the billing amount 438. Once all packages have been evaluated for a billing update, the operator performs a shipment evaluation 440 by entering the shipment evaluation system at point 204 in FIG. 2.

If the operator in the example above uses a browser with the shipment evaluation system extension, the updated billing information is saved as structured data 442. The shipment evaluation system detects this structured data or alternatively is made aware of it by the operator 444. This triggers the shipment evaluation system to read the updated billing information into an array structure 446. From this point, the system proceeds as above 436.

In a second embodiment of the billing update, FIG. 4D, the operator requests a billing report via the internet from the carrier 448. The updated billing report is delivered from the carrier. The operator then exports or prints the report as a structured data file 450. The shipment evaluation system detects the structured data or is made aware of the file by the operator 452. The shipment evaluation system then reads the updated billing information into an array structure 454. For each shipment in the update array, the Shipment evaluation system attempts to match that shipment using the unique shipment identification number to a corresponding entry in the Shipment evaluation system database. If a match is found and the package has been billed, that shipment is updated with the billing amount 456. Once all packages have been evaluated for a billing update, the operator performs a shipment evaluation 458 by entering the shipment evaluation system at point 204 in FIG. 2.

If an operator exported a history of previous shipments for evaluation as described above, they may perform an update to those shipments using a procedure similar to that shown in the embodiment of FIG. 4D. Instead of requesting a report for a current set of shipments, the user makes a request for billing data spanning the shipping dates in the historical shipment export. Once the shipment evaluation system detects the historical billing report, the flow of the system continues from point 452 in FIG. 4D.

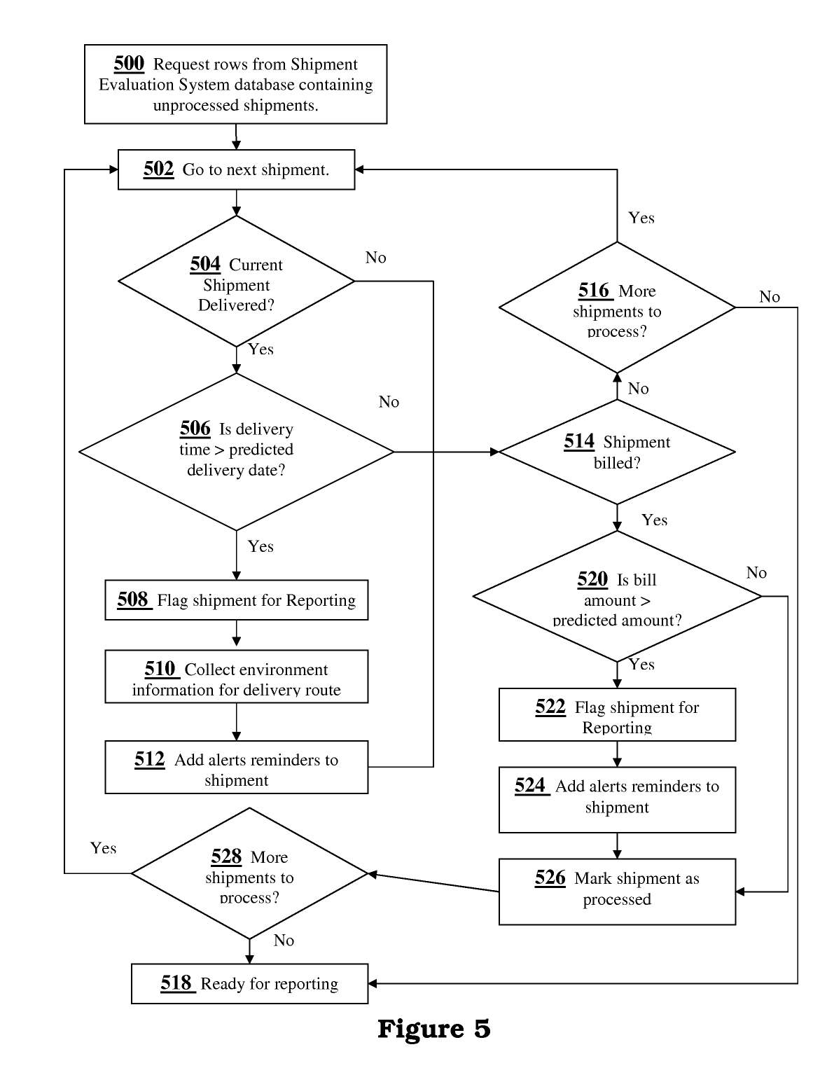

The operator enters the shipment evaluation component of the shipment evaluation system at point 204 in FIG. 2. Upon entry, the shipment evaluation system selects rows from the shipment evaluation system database containing all unprocessed shipments 500 (FIG. 5). An unprocessed shipment is one that has not been evaluated for delivery date or billing amount or both. The shipment evaluation system moves to the first record 502 and checks for delivery 504. If the shipment has been delivered, the shipment evaluation system compares the delivery date with the predicted delivery date 506. If the actual delivery date and time is greater than the predicted date and time, the shipment entry is flagged as a suspected late package in the database 508. Next, weather and other climatological data along the delivery route, and respective dates and times are gathered via the internet a stored with the flagged shipment 510. Finally, an alert to file a claim is set for this shipment 512.

Weather information is available as structured data in the form of application programming interfaces (APIs) and Simple Object Access Protocol (SOAP) objects. Notable among these service providers is WEATHERBUG, the Weather Channel, and the National Oceanic and Atmospheric Administration's (NOAA) weather API. An execution engine may be programmed to direct an I/O engine to gather weather and other climatological information at a package's origin, destination and at locations along the route where the package is routed. In certain embodiments, carriers use standardized locations for all their shipments, while other carriers may have particular routing information in response to the type of package and delivery. Similarly the GOOGLE maps API provides information on other climatological factors such as earthquakes.

The shipment evaluation system may then check to see if the shipment has been billed 514. If the shipment has not been billed, the shipment evaluation system checks to see if additional shipments require processing 516. If there are additional shipments to process, the shipment evaluation system returns to 502. If there are no additional shipments to process, the shipment evaluation system is ready for the reporting process 518 which the user may enter at point 206 in FIG. 2. If the shipment has been billed 514, the shipment evaluation system evaluates whether the bill amount exceeds the predicted bill amount 520. If it has, the shipment is flagged as an overcharged shipment 522. An alert to request a billing adjustment within the carrier-specific claim window is set 524. The shipment is marked as processed 526. Next, the shipment evaluation system checks to see if there are more shipments to process 528. If there are no more shipments to evaluate, the shipment evaluation system is ready for the reporting process 518 which the user may enter at point 206 in FIG. 2. If additional shipments are available for processing 528, the shipment evaluation system may return back to 502.

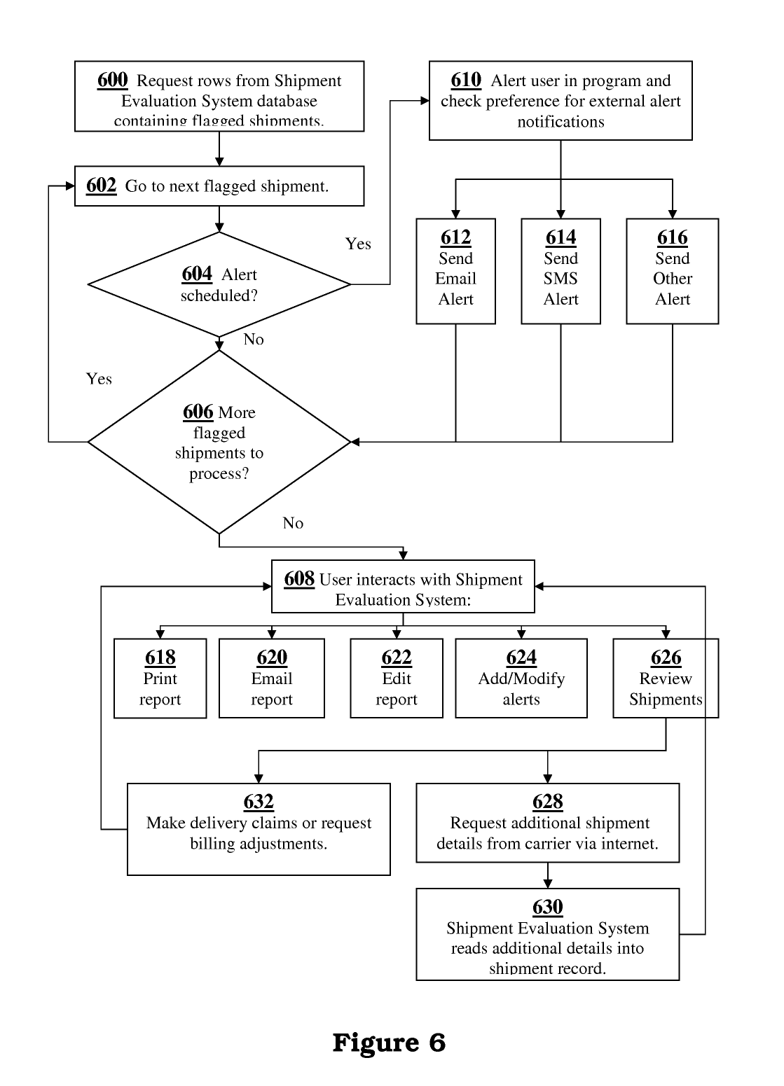

To create reports, investigate shipments in more detail and set or modify alerts, the operator enters the shipment evaluation system at point 206 in FIG. 2. From this point, the shipment evaluation system requests flagged shipment data rows from the shipment evaluation system database 600 (FIG. 6). The shipment evaluation system moves to the first record 602 and checks for alerts 604. If an alert is not scheduled, the shipment evaluation system checks for additional flagged shipments 606. If there are additional flagged shipments, the shipment evaluation system returns to point 602. If not, the operator can then interact with the shipment evaluation system 608.

From point 604, if an alert is scheduled preferences for external alerts are checked 610 and the operator is alerted. Preferences may include alerts of email 612, SMS text message 614 or other messaging technology 616. The shipment evaluation system may then check to see if other flagged shipments need processing 606. If additional flagged shipments exist, the shipment evaluation system returns to 602. If no addition alerts exist, the operator can than interact with the shipment evaluation system 608.

An operator may print reports on shipment status, flagged shipments, claims requested and adjustments requested 618. Reports can be emailed 620 or the operator can edit a report 622. Additionally, the operator can set and modify shipment alerts 624. Finally, the operator can review shipments 626. In addition, an operator may request additional information from the carrier regarding a specific shipment 628. Once the carrier returns that information, it can be saved into the shipment record 630. Also the operator can file delivery delay claims or billing adjustment requests with the carrier 632. One having skill in the art will recognize that billing adjustment requests may be filed with the carrier automatically through access with a carrier's online interface. These interfaces may already be equipped for automated processing through the use of an API, or certain embodiments may include web automation software to manipulate a carrier's internet site.

One having skill in the art would recognize that conventional programming tools such as database tools SQL Server, MYSQL and the like may be used to manipulate structured data sources. In addition, web programming tools such as FLASH, Ajax, HTML5 and the like may be employed to effectuate network operations including receiving data, formatting information, presenting it to a user and responding to user input. Conventional programming techniques including HTML injection may be employed. For example and without limitation, certain embodiments may use HTML injection when querying FedEx's server, and a weather information server, aggregate the results and present them to a user as disclosed herein

### Operation

In view of the foregoing certain embodiments according to the current disclosure may be incorporated into a processor-based system. The processor-based system may include several engines containing processor instructions for implementing the methods and processes disclosed herein. The engines may include:
(a) a user interface engine for collecting package, shipment and other information from the user;
(b) an input/output engine for controlling communications including email, reports and communications with other systems;
(c) an execution engine for orchestrating process operation among the various engines, and
(d) a data engine for accessing local and remote data sources as well as providing data maintenance operations.

A processor-based system may operate by injecting service provider specific code into browser-readable markup language that operates to perform I/O operations at the carrier service provider's server and display the results locally. This has the effect of providing a different interface than a carrier service provider and allows for aggregating information from multiple carrier services into a uniform interface. Moreover, it allows for enhanced control and storage of shipping information including information not stored by the carrier. For example and without limitation, a reseller of shipping services may charge a markup beyond what a carrier charges. A structured data source may include the selling price of the service and provide for profitability measurement by comparing selling price and actual costs.

In certain embodiments all structured data is stored locally to a user wherein certain portions of the processor instructions (those that interact with the carrier webpage) may be downloaded from an alternative server using JavaScript or HTML injection. The alternative server may be controlled by a third party and may provide code on a software-as-a-service (SaaS) model.

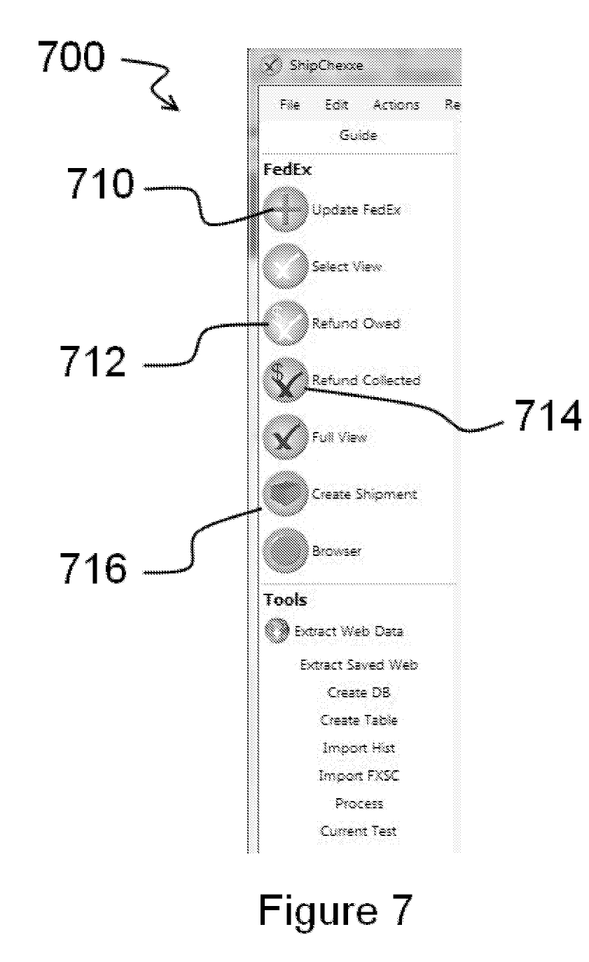

FIG. 7 illustrates certain aspects of a user interface 700 which may be used on certain embodiments. In FIG. 7 a user updates a structure data source using the Update Carrier control 710 (shown using FEDEX). The update carrier control extracts information for a selected shipment from a carrier's website. In addition is may transmit information to a carrier such as claim information. A pair of refund controls 712 and 714 allow a user to determine whether or not a refund is owed and to track whether or not that refund has been collected from the carrier. A Create Shipment control 716 provides for a user to enter shipment information according to processes described supra.

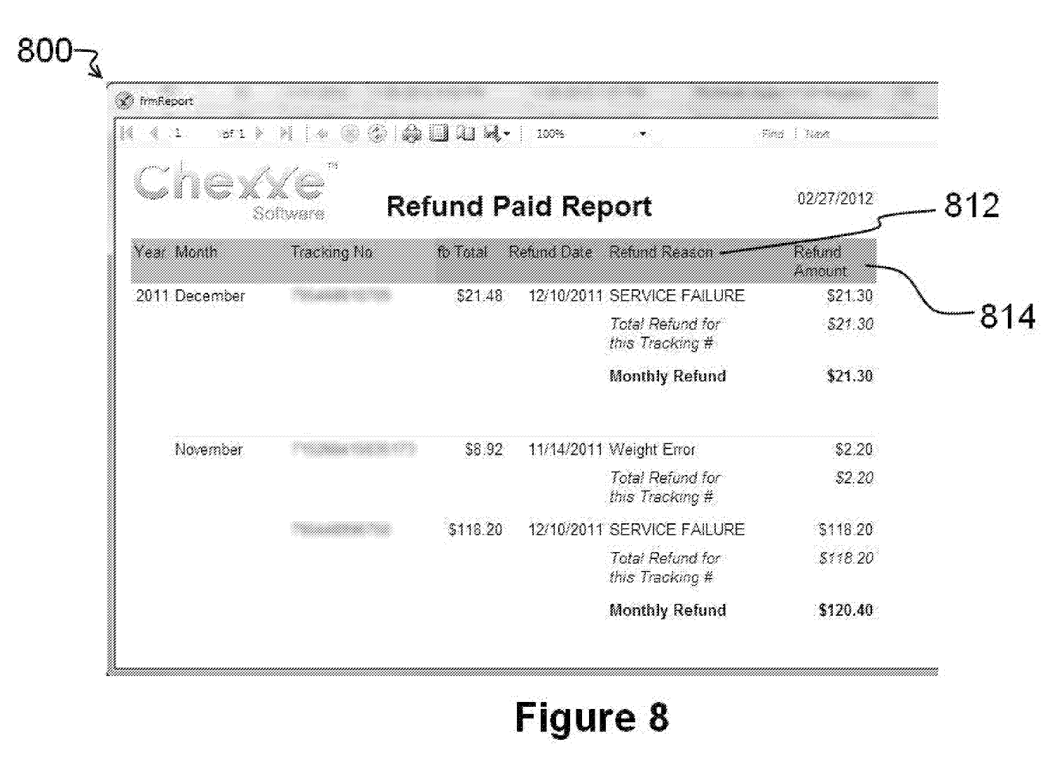

FIG. 8 shows details of a refund paid report for certain embodiments. The Refund Paid report 800 shows the reason 812 for the refund and tracks the refund amount 814 as well as providing other pertinent details such as dates and cumulative totals.

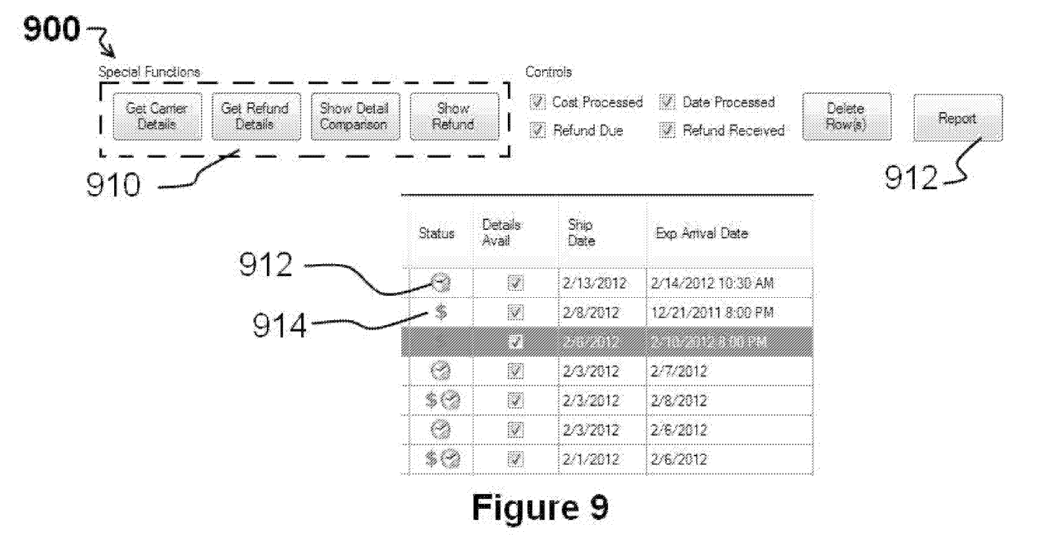

FIG. 9 shows certain controls which may be employed in refund tracking operations. In FIG. 9 controls are provided for selecting special details 910 regarding a carrier and refunds from that carrier. Data functions such as deleting rows and showing reports 912 may also be performed. Refund details may include a graphical indication such as a clock or other time indication 912 for late shipments and a currency sign 914 to indicate that a refund is due.

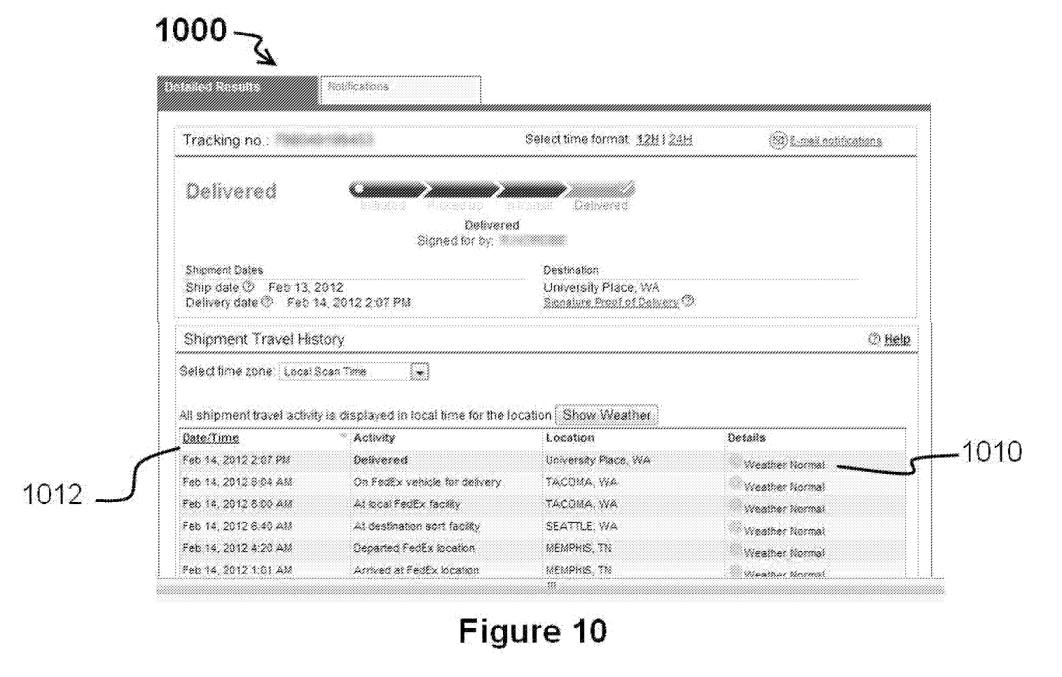

FIG. 10 shows an interface for package routing and weather information. Certain embodiments may include electronically receiving routing information from a carrier and using that routing information to identify climatological information 1010 across the entire route a package traverses. Any adverse climate conditions may justify a late package delivery, however a late delivery where there is normal weather conditions may indicate a carrier has not provided service at the agreed upon level. Improper service levels may give rise to a claim for all or a portion of the shipping costs.

In addition to climatological information, routing information may include delay time at certain stations on the route. Historical information of average wait times at particular locations may be used to identify packages that might be late or were actually delivered late. Indications of normal transit times may indicate there is no excessive delay thus obviating the need to analyze weather conditions for a give locale.

The above illustration provides many different embodiments or embodiments for implementing different features of the invention. Specific embodiments of components and processes are described to help clarify the invention. These are, of course, merely embodiments and are not intended to limit the invention from that described in the claims.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

We claim:

1. A method including the steps of:
receiving, at a server, scheduled shipping information, said scheduled shipping information including information on scheduled package delivery time and billing information;
receiving at said server, actual shipping information, said actual shipping information including actual delivery time, and actual billing information for said package;
comparing said schedule information and actual information, and reporting results of said comparing, said results including at least one of a billing discrepancy or a late delivery.

2. The method of claim 1 wherein said shipping information further includes at least one of a dimensional weight, shipping discount, shipping surcharges, weight, dimensions, taxes, or miscellaneous shipping fees.

3. The method of claim 2 wherein said reporting includes discrepancies in at least one of the dimensional weight, the shipping discount, the shipping surcharges, the recipient address, the weight, the dimensions, the taxes, miscellaneous shipping fees, duplicate charges for a single package, and charges for packages not shipped by shipper.

4. The method of claim 1 further including:
aggregating actual shipping information from different carriers, and
storing said scheduled shipping information and actual shipping information as structured data.

5. The method of claim 1 further including:
receiving climatological information, said climatological information including information from at least a package destination or a package origin;
comparing actual delivery time with the climatological information, and
reporting late deliveries in response to said comparing.

6. The method of claim 1 further including:
receiving climatological information, said climatological information including information along the package routing;
comparing actual delivery time with the climatological information, and
reporting late deliveries in response to said comparing.

7. The method of claim 1 further including:
receiving at said server, claim information, and
reporting a claim payment.

8. The method of claim 7 further including:
displaying indicia representative of said claim information.

9. A system comprising:
a processor;
a data source coupled to said processor;
a display engine, said display engine coupled to said processor and operable to receive information from a user;
an execution engine, said execution engine operable to:
receive scheduled shipping information;
receive actual shipping information;
compare said schedule information and actual information, and
report results of said comparing.

10. The system of claim 9 wherein the execution engine is further operable to aggregate actual shipping information from different carriers and store said actual shipping information as structured data.

11. The system of claim 9 wherein the execution engine is further operable to:
collect package routing information,
collect weather information in response to said routing information, and
report results of said weather information.

12. The system of claim 9 wherein the execution engine is operable to communicate refund information to a carrier system.

13. The system of claim 9 wherein the execution engine is further operable to store scheduled shipping information and actual shipping information in the data source.

14. One or more processor readable storage devices having processor readable code embodied on said storage devices, said code for programming one or more processors to perform a method comprising:
receiving scheduled shipping information, said scheduled shipping information including information on scheduled package delivery time and billing information;
receiving actual shipping information, said actual shipping information including actual delivery time, and actual billing information for said package;
comparing said schedule information and actual information, and
reporting results of said comparing, said results including at least one of a billing discrepancy or a late delivery.

15. The storage devices of claim 14 wherein said shipping information further includes at least one of a dimensional weight, estimated arrival date, shipping cost, shipping discount, shipping surcharges, recipient address, weight, dimensions, taxes, or miscellaneous shipping fees.

16. The storage devices of claim 15 wherein said reporting includes discrepancies in at least one of the dimensional weight, the estimated arrival date, the shipping cost, the shipping discount, the shipping surcharges, the recipient address, the weight, the dimensions, the taxes, miscellaneous shipping fees, duplicate charges for a single package and charges for packages not shipped by shipper..

17. The storage devices of claim 14 wherein the method further includes:
aggregating actual shipping information from different carriers, and
storing said scheduled shipping information and actual shipping information as structured data.

18. The storage devices of claim 14 wherein the method further includes:
receiving climatological information, said climatological information including information from at least a package destination or a package origin;
comparing actual delivery time with the climatological information, and
reporting late deliveries in response to said comparing.
